(19) United States
(12) Patent Application Publication
(10) Pub. No.: US 2024/0142720 A1
(43) Pub. Date: May 2, 2024

(54) FERRULE-TERMINATED HIGH-DENSITY OPTICAL FIBER CABLE ASSEMBLY

(71) Applicant: CORNING RESEARCH & DEVELOPMENT CORPORATION, Corning, NY (US)

(72) Inventors: Ming-Jun Li, Horseheads, NY (US); Qi Wu, Painted Post, NY (US)

(21) Appl. No.: 18/241,525

(22) Filed: Sep. 1, 2023

Related U.S. Application Data
(60) Provisional application No. 63/419,405, filed on Oct. 26, 2022.

(51) Int. Cl. G02B 6/38; G02B 6/36

(52) U.S. Cl. CPC G02B 6/3885; G02B 6/3672; G02B 6/368; G02B 6/3889; G02B 6/3861

(57) ABSTRACT

A high fiber count, ferrule-terminated optical fiber cable assembly includes a high density two-dimensional array of optical fibers extending through a single aperture of a ferrule, with the optical fibers within the ferrule aperture each having a core, a cladding layer, and a hard coating layer (e.g., having an elastic modulus greater than 100 MPa). Hard coated optical fibers are arranged very close to (e.g., within two microns of, or in contact with) one another, with a substantially constant fiber pitch within the ferrule. A fusion splice region may be provided between ferrule terminated hard-coated optical fibers and conventional optical fibers lacking a hard coating. High optical fiber density and compact ferrule size permits a significant reduction in connector width, enabling a numerical reduction or elimination of staggered lengths of cable portions for coupling ultra-high density optical fiber cables.

### PRIORITY APPLICATION

This application claims the benefit of priority of U.S. Provisional Application No. 63/419,405, filed on Oct. 26, 2022, the content of which is relied upon and incorporated herein by reference in its entirety.

### BACKGROUND

The disclosure relates generally to fiber optic cable assemblies incorporating two-dimensional arrays of optical fibers in a high-density manner, as well as methods for fabricating such assemblies.

Optical fibers are useful in a wide variety of applications, including the telecommunications industry for voice, video, and data transmission. Fiber optic cables are frequently produced by extruding thermoplastic and/or acrylic coating material (e.g., polyvinylchloride (PVC)) over at least one coated optical fiber. FIG. 1 is a cross-sectional view of an exemplary coated optical fiber 10 (e.g., having an outer diameter of about 200 μm, about 250 μm, or any other suitable value) about that includes a glass core 12, glass cladding 14 surrounding the glass core 12, and a multi-layer polymer coating 20 (including an inner primary coating layer 16 and an outer secondary coating layer 18) surrounding the glass cladding 14. The inner primary coating layer 16 may be configured to act as a shock absorber to minimize attenuation caused by any micro-bending of the coated optical fiber 10.

One method of joining optical fibers is optical fiber fusion splicing, by which a permanent, low-loss, high-strength, fused (or welded) joint is formed between two optical fibers, typically involves multiple tasks. First, polymeric coatings (e.g., coating layers 16, 18 of FIG. 1) of coated optical fibers (e.g., coated optical fiber 10 of FIG. 1) are stripped to expose glass cladding (e.g., glass cladding 14 of FIG. 1). Next, flat fiber end faces are formed, typically by cleaving exposed glass portions of the fibers. The fibers are laterally aligned to each other, then the fiber tips are heated to their softening point and pressed together to form a joint. FIG. 2 schematically illustrates a fusion spliced optical fiber segment 24 including splice joint 22 arranged between (stripped) glass cladding segments 14A, 14B of two respective optical fibers 10A, 10B. After fusion splicing is performed, a fusion splice region is typically protected from the environment with a suitable overcoating (e.g., acrylic and/or thermoplastic material) or other packaging.

Mass fusion splicing is a high throughput technology for interconnecting large number of fibers in a ribbon format. First and second segments of multiple (e.g., up to twelve) fibers arranged in a linear array can be fusion spliced simultaneously by mass fusion splicing. Since sequential formation of twelve fusion splices using a traditional single fiber fusion splicing technique is very time consuming, the ability to fusion splice linearly arrayed segments of multiple fibers simultaneously enables entire ribbons to be spliced rapidly.

In a telecommunications system that uses optical fibers, there are typically many locations where fiber optic cables that carry the optical fibers connect to equipment or other fiber optic cables. To conveniently provide these connections, optical connectors are often provided on the ends of fiber optic cables. Many different types of optical connectors exist, including multi-fiber optical connectors. One example is the multi-fiber push on (MPO) connector having up to 24 optical fibers (e.g., received in two rows of twelve micro-holes defined in a ferrule), with a MPO connector incorporating a mechanical transfer (MT) ferrule being standardized according to TOA-604-5 and IEC 61754-7.

Hyperscale datacenters (including single-hall and multi-hall facilities) continue to proliferate in number and size at an accelerated pace, driven not only by video streaming and social media, but also increasingly by machine learning and artificial intelligence applications. Interconnects between datacenter campus buildings as well as between regional datacenters require very high fiber count cables that are typically deployed in conduits. Datacenters typically include pre-installed ducts (e.g., with diameters ranging from 1 to 4 inches) for connecting buildings. The current state of the art of ultra-high fiber count cables includes providing up to 6,912 optical fibers in a single cable having an outer diameter of no greater than 30 mm. With further reduction in fiber diameters of next-generation optical fibers, higher fiber counts and higher density cables are anticipated to be developed to meet customer demands without changing existing duct infrastructure.

In the context of datacenters, outside plant cables are transitioned to indoor cables at the point of entry into the building according to prevailing building codes. Although field fusion splicing was previously adopted for connecting outside plant cables to indoor cables, fusion splicing is slow and costly in the field, requiring highly skilled technicians. The limited pool of specialized workers also fails to keep up with demand growth. To address this issue, a pre-terminated inside/outside plant cable solution has gained acceptance. Installing pre-terminated cables through ducts is challenging since the connectors need to be packaged in a pulling grip that conforms to the cable diameter, wherein a lack of high fiber count connectors in combination with increased fiber density exacerbates the problem.

An existing solution utilizes 24-fiber MPO-type connectors to terminate groups of fibers, wherein a total of 288 of these connectors, arranged in staggered lengths and enclosed in a pulling grip, are needed to terminate a 6,912 fiber cable. An ideal connectivity between a furcated outside plant cable and an indoor cable would have a single connection or a small number of connections. Unfortunately, commercially available MPO ferrules are limited to 32 optical fibers, and scaling such ferrules to provide higher fiber counts has proven to be cost prohibitive, due to reduced yield in both ferrule fabrication and connector assembly processes. Other types of high fiber count connector utilizing precision micro-hole plates face the same challenges as MPO ferrules.

Recently developed high-density cables are designed without a central tube, and utilize rollable ribbons of optical fibers with maximum fiber packing density. To facilitate passage of pre-connectorized cables of this type through ducts during installation, the outer diameter of a pulling grip needs to match that of the cable. The available cross-sectional space in a pulling grip to accommodate the connectors is roughly equal to the thickness difference between the cable jacket and the pulling grip. For example, a 6,912 fiber cable having a 30 mm diameter has less than 100 mm² of available cross-sectional area for connectors. If standard MPO-type ferrules having a 3×7 mm² cross section are used, then each stagger can have only 5 connectors. If 24-fiber MPO ferrules are used to terminate a 6,912 fiber cable, the number of staggers would be too numerous to be practical.

As a departure from precision micro-hole plate designs, “matched pair” connectors have been developed to accommodate larger numbers of optical fibers. If a matched pair connector terminates 144 optical fibers each having a 200 micron diameter in an 8 mm diameter ferrule, the cross-section of the fiber array is about 5.8 mm²; however, the cross-section of the connector ferrule is much larger at 50 mm²., such that only one or two such ferrules could be accommodated in the 100 mm² available area if a pulling grip is used with a 6,912 fiber cable. The 8 mm diameter ferrule of a matched pair connector is also too large to fit most micro-ducts that are used to fit low fiber count micro cables. In the production of a matched pair, a multitude of continuous optical fibers are fixed in place in at least one section of a cable before the optical fibers are cut to form adjacent fiber optic connectors in a cable system, whereby fiber ordering between adjacent fiber optic connectors will be the same even though fiber ordering may have been random during cable preparation. However, matched pair connectors are not randomly matable with other connectors, since each single connector is only matable with its manufactured counterpart. If one matched connector fails, then both connectors of the matched pair must be cut off and replaced with field splicing.

Need therefore exists in the art for higher density fiber count connectors characterized by random matability and that exhibit a ferrule cross section that is comparable to that of a terminated fiber group, preferably in such a manner that would reduce or (even more preferably) eliminate the need for utilizing multiple connectorized fiber groups of staggered lengths of cable portions for coupling ultra-high density optical fiber cables. It would also be desirable to enable pre-terminated lower fiber count micro cables to be deployed in micro-ducts.

### SUMMARY

Aspects of the present disclosure provide a high fiber count, ferrule-terminated optical fiber cable assembly including a high density two-dimensional array of optical fibers extending through a single aperture of a ferrule, with the optical fibers within the ferrule aperture each having a core, a cladding layer, and a hard coating layer. Such an assembly may include optical fibers arranged very close to (e.g., within two microns of, or in contact with) one another, with a substantially constant pitch within a ferrule, providing random matability between connectors. High optical fiber density and compact ferrule size permits a significant reduction in connector width, enabling a numerical reduction or elimination of staggered lengths of cable portions for coupling ultra-high density optical fiber cables.

In one aspect, the disclosure relates to a high fiber count, ferrule-terminated optical fiber cable assembly that comprises a ferrule body having a front end face, a rear end face, and an aperture extending between the front end face and the rear end face, wherein the optical fiber cable assembly further comprises a first two-dimensional array of optical fibers having a substantially constant first fiber pitch extending through the aperture of the ferrule body and terminated at the front end face. Each optical fiber of the first two-dimensional array comprises a core, a cladding layer, and a hard coating layer having a Young's modulus greater than 100 MPa, wherein each optical fiber of the first two-dimensional array has an outer diameter in a range of 100 microns to 150 microns, and wherein, within the aperture of the ferrule body, each optical fiber in the first two-dimensional array is arranged within two microns of each adjacent optical fiber in the first two-dimensional array.

In certain embodiments, at least some optical fibers in the first two-dimensional array are arranged in contact with one or more adjacent optical fibers of the first two-dimensional array within the aperture of the ferrule body.

In certain embodiments, each optical fiber of the first two-dimensional array comprises a stripped region and an unstripped region, wherein in the unstripped region each optical fiber comprises the core, the cladding layer, the hard coating layer, and at least one outer polymeric coating disposed around the hard coating layer, and wherein in the stripped region each optical fiber is devoid of an outer polymeric coating disposed around the hard coating layer, the stripped region including an end stripped region and a medial stripped region; the end stripped region of each optical fiber of the first two-dimensional array extends within the aperture of the ferrule body; the first two-dimensional array comprises a second fiber pitch corresponding to the unstripped region of each optical fiber of the first two-dimensional array, the second fiber pitch being greater than the first fiber pitch; and for each optical fiber of the first two-dimensional array a pitch transition area including the medial stripped region is arranged between the unstripped region and the end stripped region.

In certain embodiments, the optical fiber cable assembly further comprises a second two-dimensional array of optical fibers, each optical fiber of the second two-dimensional array comprising a stripped region and an unstripped region, wherein in the stripped region each optical fiber comprises a core and a cladding layer, and in the unstripped region each optical fiber comprises the core, the cladding layer, and at least one outer polymeric coating layer disposed around the cladding layer; and a fusion splice region between the first two-dimensional array of optical fibers and the stripped region of the second two-dimensional array of optical fibers, wherein each optical fiber of the first two-dimensional array of optical fibers is fusion spliced to a corresponding fiber of the second two-dimensional array of optical fibers; wherein the first two-dimensional array of optical fibers has a fiber pitch that transitions from a larger pitch proximate to the fusion splice region to a smaller pitch proximate to the ferrule.

In certain embodiments, the optical fiber cable assembly further comprises a thermoplastic material encapsulating the fusion splice region.

In certain embodiments, the ferrule body comprises an outer shape selected from square, rectangular, round, and hexagonal.

In certain embodiments, the optical fiber cable assembly further comprises adhesive material arranged in interstitial spaces between optical fibers of the first two-dimensional array within the aperture of the ferrule body.

In certain embodiments, the hard coating layer has a thickness in a range of from 1 μm to 15 μm; the ferrule body has a length in a range of from 3 mm to 15 mm; and/or the first two-dimensional array comprises at least 72 optical fibers.

In another aspect, the disclosure relates to a high fiber count, ferrule-terminated optical fiber cable assembly that comprises a ferrule body having a front end face, a rear end face, and an aperture extending between the front end face and the rear end face, wherein the optical fiber cable assembly further comprises a plurality of optical fibers each having a stripped region and an unstripped region. In the stripped region, each optical fiber comprises a core, a cladding layer, and a hard coating layer having a Young's modulus greater than 100 MPa, and in the unstripped region each optical fiber comprises the core, the cladding layer, the hard coating layer, and at least one outer polymeric coating layer disposed around the hard coating layer, wherein the stripped region includes an end stripped region and a medial stripped region. The plurality of optical fibers in the end stripped region forms a first two-dimensional array having a first fiber pitch extending through the aperture and being terminated at the front end face, and the plurality of optical fibers in the unstripped region forms a second two-dimensional array having a second fiber pitch that is larger than the first fiber pitch.

In certain embodiments, the ferrule body has a first maximum lateral dimension taken parallel to the front end face; the second two-dimensional array has a second maximum lateral dimension; and the second maximum lateral dimension no more than two times greater than the first maximum lateral dimension.

In certain embodiments, the second maximum lateral dimension is no greater than the first maximum lateral dimension.

In certain embodiments, at least some optical fibers in the first two-dimensional array are arranged in contact with adjacent optical fibers of the first two-dimensional array within the aperture of the ferrule body.

In certain embodiments, for each optical fiber of the plurality of optical fibers, a pitch transition area including the medial stripped region is arranged between the unstripped region and the end stripped region.

In another aspect, the disclosure relates to an optical fiber assembly that comprises an optical fiber cable including a plurality of optical fibers in a numerical range of from 1,728 to 13,824 optical fibers, and having a cable outer diameter, wherein the optical fiber assembly further comprises a pulling grip having an outer diameter no more than 5 percent greater than the cable outer diameter, and a plurality of ferrules each terminating a different subgroup of the plurality of optical fibers to form a plurality of terminated subgroups. Each terminated subgroup of the plurality of terminated subgroups comprises 72 to 432 optical fibers. Additionally, each terminated subgroup of the plurality of terminated subgroups has substantially the same length, or the plurality of terminated subgroups consists of terminated subgroups having no more than three different staggered lengths.

In certain embodiments, each ferrule of the plurality of ferrules comprises a ferrule body having a front end face, a rear end face and an aperture extending between the front end face and the rear end face; and each terminated subgroup of the plurality of terminated subgroups comprises a two-dimensional array of optical fibers extending through an aperture of a corresponding ferrule of the plurality of ferrules and terminated at the front end face of the corresponding ferrule.

In certain embodiments, within each two-dimensional array of optical fibers, each optical fiber comprises a core, a cladding layer, and a hard coating layer having a Young's modulus greater than 100 MPa, and each optical fiber has an outer diameter in a range of 100 microns to 150 microns.

In certain embodiments, within each ferrule of the plurality of ferrules, each optical fiber in the two-dimensional array of optical fibers is arranged within two microns of each adjacent optical fiber of the two-dimensional array of optical fibers.

In certain embodiments, within each ferrule of the plurality of ferrules, at least some optical fibers in the two-dimensional array of optical fibers is arranged in contact with one or more adjacent optical fibers of the two-dimensional array of optical fibers.

Additional features and advantages will be set forth in the detailed description which follows, and in part will be readily apparent to those skilled in the technical field of optical connectivity. It is to be understood that the foregoing general description, the following detailed description, and the accompanying drawings are merely exemplary and intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a cross-sectional view of a conventional coated optical fiber.

FIG. 2 is a side elevational view of a fusion spliced optical fiber section including a splice joint between stripped glass cladding segments of two optical fibers.

FIG. 3A is a cross-sectional view of an unstripped optical fiber including a core, cladding, a hard coating layer, and two outer polymeric coating layers.

FIG. 3B is a cross-sectional view of a stripped optical fiber starting with the items of FIG. 3A, following removal of the outer polymeric coating layers.

FIG. 4A is a perspective view of a portion of an optical fiber cable assembly according to one embodiment, including 144 optical fibers each having an unstripped region and a stripped region, with an end stripped region of each optical fiber being arranged in a first two-dimensional array with a first fiber pitch extending through an aperture of a ferrule, with an unstripped region of each optical fiber being arranged in a second two-dimensional array having a second fiber pitch outside of the ferrule, and a pitch transition area therebetween including a medial stripped region of each optical fiber.

FIG. 4B is a top plan view of the optical fiber cable assembly of FIG. 4A.

FIG. 5 is a front elevational view of the optical fiber cable assembly of FIGS. 4A-4B.

FIG. 6 is a rear elevational view of the optical fiber cable assembly of FIGS. 4A-4B.

FIG. 7 is a magnified (i.e., lower left) portion of FIG. 5.

FIG. 8A is a perspective view of an optical fiber cable assembly according to another embodiment having fusion spliced optical fibers of two different types, the assembly including 144 first optical fibers each having a core, cladding, and hard coating layer arranged in a 12×12 array terminated by a ferrule, with the first optical fibers joined at a fusion splice region to stripped portions of 144 second optical fibers devoid of a hard coating layer, with the stripped portions of the second optical fibers having a core and cladding, and with unstripped portions further including outer polymeric coating layers.

FIG. 8B shows a protected optical fiber cable assembly including the optical fiber cable assembly of FIG. 8A, following addition of a protective coating over the fusion splice region as well as exposed portions of the first and second optical fibers.

FIG. 9 is front elevational view of an optical fiber cable assembly including 48 ferrules arranged without staggering within a pulling grip.

FIG. 10A is a front elevational view of at least a portion of an optical fiber cable assembly including a ferrule with a round cross-sectional shape having a two-dimensional array of optical fibers terminated therein, according to one embodiment.

FIG. 10B is a front elevational view of at least a portion of an optical fiber cable assembly including a ferrule with a hexagonal cross-sectional shape having a two-dimensional array of optical fibers terminated therein, according to one embodiment.

FIG. 10C is a front elevational view of at least a portion of an optical fiber cable assembly including a ferrule with a rectangular cross-sectional shape having a two-dimensional array of optical fibers terminated therein, according to one embodiment.

### DETAILED DESCRIPTION

Various embodiments will be further clarified by examples in the description below. In general, the description relates to a high fiber count, ferrule-terminated optical fiber cable assembly including a high density two-dimensional array of optical fibers extending through a single aperture of a ferrule, with the optical fibers within the ferrule aperture each having a core, a cladding layer, and a hard coating layer (having a Young's modulus greater than 100 MPa or another threshold recited herein), but devoid of conventional primary and/or secondary polymeric coating layers. Such a cable assembly may include optical fibers arranged very close to (e.g., within two microns of, or in contact with) one another, with a substantially constant pitch within a ferrule, providing random matability between connectors. Providing high optical fiber density and compact ferrule size permits a significant reduction in connector width, such that a number of staggered lengths of cable portions may be reduced or eliminated in the context of coupling ultra-high density optical fiber cables. When an optical fiber cable assembly includes optical fibers each including a hard coating layer, with a stripped region and an unstripped region thereof (in which the unstripped region includes at least one outer thermoplastic coating layer that is not present in the stripped region), the stripped optical fibers extending through a ferrule aperture are provided in a first two dimensional array having a smaller fiber pitch than a fiber pitch of unstripped optical fibers that are arranged in a second two-dimensional array. A fiber pitch transition region of stripped optical fibers may be arranged between the preceding two arrays.

Providing optical fibers with a thin layer of hard coating material is disclosed in U.S. Patent Application Publication No. 2022/0026604 A1 entitled “Single-Mode Optical Fiber with Thin Coating for High Density Cables and Interconnects,” wherein the entire contents of the foregoing published application are hereby incorporated by reference herein. Such publication discloses use of a thin hard coating layer that provides protection to an optical fiber and enables a hard coated fiber to be inserted into a ferrule bore with the coating present. This thin hard coating layer may have a thickness between 0.1 μm and 10 μm, and may be formed of various materials including UV-cured acrylates or organic UV-curing acrylate resins filled with SiO₂ or ZrO₂ nanoparticles or non-acrylate polymers such as polyimides, optionally in combination of a silane additive (e.g., acryloxy silanes, methacrylate silanes, or Mercapto silanes, such as (3-Mercaptopropyl)trimethoxysilane and (3-acryloxypropyl)trimethoxysilane) to promote bonding to glass or inorganic surfaces. Such a thin hard coating material may have a Shore D hardness value greater than 60 (or greater than 70, greater than 80, greater than 90, or a value of about 95), a pencil hardness value greater than 3H, greater than 4H, or greater than 5H on polymethylmethacrylate PMMA film, and a concentricity relative to a fiber core ranging between 0.1 μm and 0.5 μm (thereby maintaining high geometric precision). Such a coating may have an elastic modulus of at least 100 MPa, at least 300 MPa, at least 1 GPa, or at least 2.5 GPa. In certain embodiments of the present disclosure, a hard coating as disclosed by the above-identified publication may be used, with a thickness range of from 1 μm to 15 μm, and with thickness that is highly consistent both along the fiber axis and around the circumference, thus maintaining very high core concentricity (i.e., less than ±0.5 μm) and overall diameter consistency (diametric variation tolerance of less than ±0.3 μm).

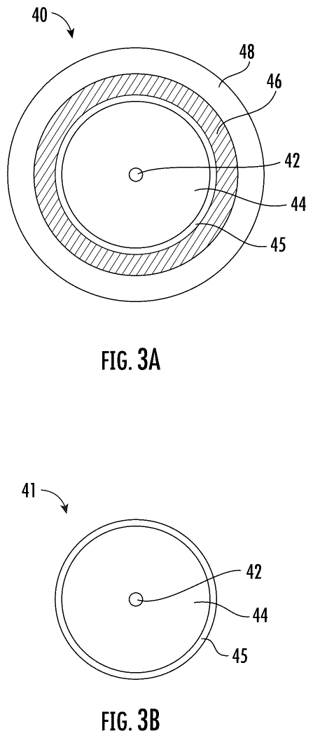

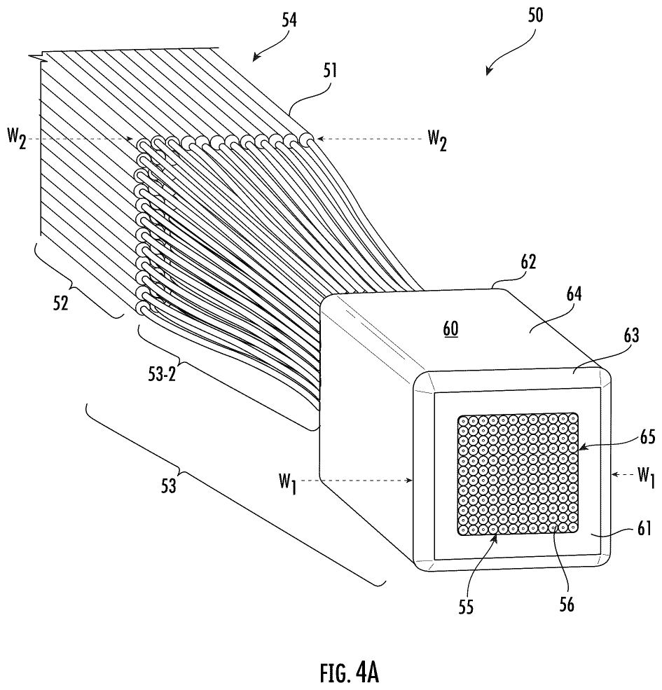

Although the above-described hard coating layer may be beneficially used in ferrules terminating fiber optic cables, if a soft primary coating layer is omitted, then micro bend loss will be elevated, particularly for long wavelength signals transmitted over a long propagation length. One approach to mitigate this micro bend loss is to add a soft primary coating and a hard secondary coating on top of the thin hard coating layer. An example of such an optical fiber 40 is shown in FIG. 3A. The optical fiber 40 includes a glass core 42, glass cladding 44 surrounding the glass core 42, a hard coating layer 45 surrounding the glass cladding 44, soft primary polymer coating layer 46 surrounding the hard coating layer 45, and a secondary polymer coating layer 48 surrounding the primary polymer coating layer 46. While the primary polymer coating layer 46 acts as a shock absorber to minimize attenuation caused by micro-bending of the optical fiber 40, the secondary polymer coating layer 48 may be configured protect the primary polymer coating layer 46 against mechanical damage, and to act as a barrier to lateral forces. The outer diameter of the coated optical fiber 40 may be in a range of from 120 μm to 250 μm, or in a range of from 165 μm to 250 μm, or the outer diameter may be one of the following values: 250 μm, 200 μm, 190 μm, 180 μm, 170 μm or 165 μm. Optionally, an ink layer (not shown, but having a thickness of about 5 μm) may be arranged over the secondary polymer coating layer 48 to color the fiber (e.g., as is commonly used in ribbonized optical fibers), or a coloring agent may be mixed with the coating material that forms the secondary polymer coating layer 48. The optical fiber 40 in unstripped form (i.e., with primary and secondary polymer coating layers 46, 48 intact) is suitable for conveying signals over long distances. When it is time to terminate the optical fiber 40, the primary and secondary polymer coating layers 46, 48 may be stripped away to yield a stripped optical fiber 41 with the hard coating layer 45 remaining over the cladding 44 and core 42, as shown in FIG. 3B. In certain embodiments, the stripped optical fiber 41 has an outer diameter in a range of from 80 μm to 150 μm, or in a range of from 100 μm to 140 μm, or in a range of from 120 μm to 130 μm. In certain embodiments, the optical fiber 41 of FIG. 3B having a hard coating layer 45 arranged over cladding 44 and a core 42 may be devoid of any primary and secondary polymer coatings at the outset, and thus may not require stripping.

Any suitable non-contact methods and/or apparatuses, such as those disclosed in U.S. Pat. No. 9,167,626 B2 (i.e., “the '626 Patent,”, which is hereby incorporated by reference herein) may be used to strip the primary and secondary polymer coating layers 46, 48 of the optical fiber 40 of FIG. 3A to yield a stripped optical fiber 41 according to FIG. 3B. Briefly, the '626 Patent discloses use of a heater configured for heating a heating region to a temperature above a thermal decomposition temperature of at least one coating of an optical fiber, a securing mechanism for securely positioning a lengthwise section of the optical fiber in the heating region, and a controller operatively associated with the heater and configured to deactivate the heater no later than immediately after removal of the at least one coating from the optical fiber. In certain embodiments, the hard coating layer 45 of FIG. 3A has a higher thermal decomposition temperature than each of the primary and secondary polymer coating layers 46, 48. Thermal decomposition of at least one coating of an optical fiber reduces or minimizes formation of flaws in optical fibers that may be generated by mechanical stripping methods and that can reduce their tensile strength.

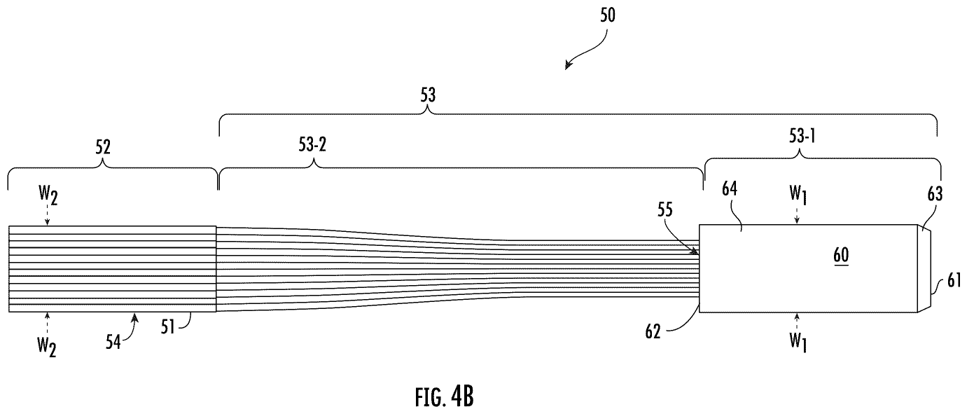

FIGS. 4A-4B show a high fiber count, ferrule-terminated optical fiber cable assembly 50 including a ferrule 60 and including optical fibers 51 each having a hard coating layer over cladding and a core (as described previously herein, such as in connection with FIGS. 3A-3B), according to one embodiment. The ferrule 60 includes a body 64 (e.g., of ceramic, metal, polymeric, or composite materials) having at least one wall surrounding an aperture 65 that extends between a rear end face 62 and a front end face 61 of the ferrule 60, with the front end face 61 including a beveled portion 63. In certain embodiments, the ferrule body 64 has a length in a range of from 3 mm to 15 extending from the rear end face 62 to the front end face 61. Although the ferrule 60 is illustrated as having a square-shaped cross-section, it is to be appreciated that a ferrule may comprise any desired cross-sectional shape (e.g., including, but not limited to, square, rectangular, round, hexagonal, and regular or irregular polygon shapes). The optical fibers 51 are arranged in twelve rows of twelve fibers each, totaling 144 in number. Each optical fiber 51 includes an unstripped region 52 and a stripped region 53, with the unstripped region 52 including at least one outer polymeric coating layer surrounding the hard coating layer, wherein the stripped region 53 is devoid of any polymeric coating layer (such that the hard coating layer is exposed), such that each optical fiber 51 has a larger outer diameter in the unstripped region 52 than in the stripped region 53. In certain embodiments, the unstripped region 52 includes multiple ribbons (e.g., 12 ribbons each including 12 optical fibers, or any suitable number of ribbons and/or fibers therein), wherein the ribbons may optionally comprise rollable ribbons. The stripped region 53 includes a medial stripped region 53-2 and an end stripped region 53-1, wherein the end stripped region 53-1 of each optical fiber 51 extends through the aperture 65 of the ferrule 60, with ends 56 of the optical fibers 51 being terminated substantially flush with the front end face 61 of the ferrule 60.

As shown in FIG. 4A, in the end stripped region 55, the optical fibers 51 form a first two-dimensional array 55 having a substantially constant first fiber pitch (i.e., center-to-center spacing between adjacent optical fibers 51), while in the unstripped region 52, the optical fibers 51 form a second two-dimensional array 54 having a substantially constant second fiber pitch that is greater than the first fiber pitch. Additionally, as shown in FIGS. 4A-4B, a fiber pitch between optical fibers 51 transitions from the first fiber pitch to the second fiber pitch in at least a portion of the medial stripped region 53-2 to form a pitch transition area. In certain embodiments, fiber pitch varies over substantially an entirety of the medial stripped region 53-2 such that a pitch transition area is coextensive with the medial stripped region 53-2, whereas in other embodiments only a portion of the medial stripped region 53-2 embodies a pitch transition area, while a portion of the medial stripped region 53-2 proximate to the first two-dimensional array 55 has the first fiber pitch, and a portion of the medial stripped region 53-2 proximate to the second two-dimensional array 54 has the second fiber pitch.

In certain embodiments, each optical fiber 51 of the first two-dimensional array 55 (e.g., within the aperture 65 of the ferrule 60) has an outer diameter in a range of from 80 μm to 150 μm (or in a range of from 80 μm to 150 μm, or another range disclosed herein), and each optical fiber in the second two-dimensional array 54 has a diameter in a range of from 120 μm to 250 μm (or in a range of 150 μm to 250 μm, or another range disclosed herein). The reduced diameter of optical fibers 51 in the first two-dimensional array 55 relative to the second two-dimensional array 54 permits the optical fibers 51 to have a smaller pitch in the first two-dimensional array 55 than in the second two-dimensional array 54. To reduce the size of the ferrule aperture 65 (and therefore the ferrule 60) to the extent possible, in certain embodiments each optical fiber 51 in the first two-dimensional array 55 is in contact with one or more adjacent optical fibers 51 of the first two-dimensional array 55. However, to accommodate manufacturing variability and tolerances, in certain embodiments each optical fiber 51 in the first two-dimensional array 55 is arranged within 2 μm of one or more adjacent optical fibers 51 of the first two-dimensional array 55. The ferrule aperture 65 may have width and height dimensions slightly larger (e.g., in a range of 1 μm to 10 μm larger, or in a range of 2 μm to 8 μm larger, or in a range of 1 μm to 5 μm larger) than an aggregate width and aggregate height of the first two-dimensional array 55, to enable insertion of the first two-dimensional array 55 of optical fibers 51 through the ferrule aperture 65 during fabrication of the cable assembly 50. As shown, the ferrule body 64 has a first maximum lateral dimension (e.g., width) W₁ taken parallel to the front end face 61 of the ferrule 60, and the second two-dimensional array 54 of optical fibers 51 in the unstripped region 52 has a second maximum lateral dimension (e.g., width) W₂, in a direction perpendicular to cores of the optical fibers 51 in the second two-dimensional array 54. In certain embodiments, the second maximum lateral dimension W₂ is no more than two times greater (or no more than 1.5 times greater, or no more than 1.25 times greater, or no more than 1.1 times greater, or no more than 1.05 times greater, or no more than 1 times greater) than the first maximum lateral dimension W₁. If the maximum lateral dimension W₁ of the ferrule 60 is similar to the maximum lateral dimension W₂ of the second two-dimensional array, that would enable a number of staggered lengths of cable in a pulling grip to be reduced or eliminated altogether. In certain embodiments, the ferrule 60 (containing 144 optical fibers 51) has lateral dimensions of 2.5 mm×2.5 mm, such that the maximum lateral dimension W₁ of the ferrule would be 2.5 mm.

Although FIGS. 4A-4B show the medial stripped region 53-2 as being exposed, in certain embodiments this medial stripped region 53-2 may be encapsulated with a suitable protective material, such as a protective coating of thermoplastic material, adhesive material, epoxy material, or the like. In certain embodiments, a protective coating over the medial stripped region 53-2 may be formed by placing the medial stripped region 53-2 into a mold cavity (not shown), flowing molten thermoplastic material into the mold cavity, and allowing the molten thermoplastic to cool and solidify around the medial stripped region 53-2. In certain embodiments, a molten thermoplastic coating may have a maximum lateral dimension no greater than (or no more than 5% or 10% greater than) the maximum lateral dimension W₂ of the second two-dimensional array 54 of optical fibers 51.

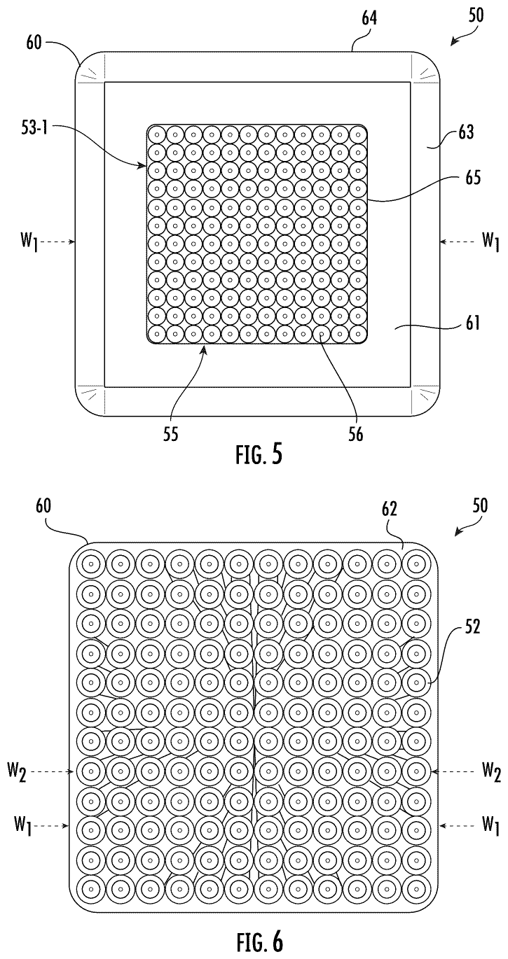

FIG. 5 is a front elevational view of the optical fiber cable assembly 50 of FIGS. 4A-4B, showing the front end face 61 of the ferrule 60 with ends 56 of the optical fibers of the first two-dimensional array 55 being terminated substantially flush with the front end face 61, which is surrounded by beveled portion 63. End stripped regions 53-1 of optical fibers of the first two-dimensional array 55 are closely packed (e.g., contacting one another, or arranged within 2 μm of one another) within the aperture 65 of the ferrule 60. FIG. 6 is a rear elevational view of the optical fiber cable assembly 50 of FIGS. 4A-4B, showing unstripped regions 52 of optical fibers (having an aggregate maximum lateral dimension W₂) superimposed over the rear end face 62 of the ferrule 60 (having a maximum lateral dimension W₁), wherein W₁ is slightly larger (e.g., less than 10 percent larger or less than 5 percent larger) than W₂.

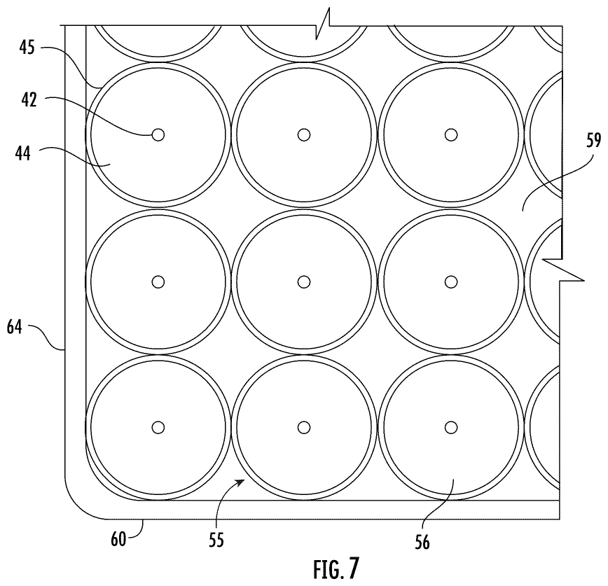

FIG. 7 is a magnified (i.e., lower left) portion of FIG. 5, showing ends 56 of optical fibers of the first two-dimensional array 55 arranged in contact with one another within the aperture 65 defined in the ferrule body 64. The end 56 of each optical fiber exposes a fiber core 42 surrounded by cladding 44, with the cladding 44 surrounded by a hard coating layer 45. In certain embodiments, adhesive and/or encapsulant material (e.g., thermoplastic adhesive material, epoxy, chemically- or thermally-activated adhesive, etc.) may be provided in interstitial spaces 59 between optical fibers of the first two-dimensional array 55 within the ferrule 60, to provide a permanent mechanical connection therebetween. Polishing of ends 56 of the optical fibers of the first two-dimensional array may be performed after the adhesive material in the interstitial spaces 59 is cured.

In certain embodiments, a high fiber count, ferrule-terminated optical fiber cable assembly includes first and second two-dimensional arrays of optical fibers with a fusion splice region between the arrays. The first two dimensional array of optical fibers includes a core, a cladding layer, and a hard coating layer having a Young's modulus value greater than 100 MPa, with each optical fiber therein having an outer diameter in a range of 80 μm to 150 μm (or in a range of 100 μm to 150 μm, or in another range disclosed herein) and each optical fiber being devoid of an individual outer polymeric coating disposed around the hard coating layer. The first two-dimensional array of optical fibers has a fiber pitch that transitions from a larger fiber pitch proximate to the fusion splice region to a smaller fiber pitch proximate to a ferrule, wherein the optical fibers of the first two-dimensional array extend through an aperture of a body of the ferrule and are terminated at a ferrule front end face. The second two-dimensional array of optical fibers includes a stripped portion and an unstripped portion (each including a core surrounded by cladding), with the unstripped region including one or more outer polymeric coating layers. In certain embodiments, optical fibers of the second two-dimensional array are devoid of any hard coating layer surrounding the cladding layer; in this respect, optical fibers of the two-dimensional array may differ in type from optical fibers of the first two-dimensional fibers. The fusion splice region between the first and second two-dimensional arrays permits coupling of cores of optical fibers of the first two-dimensional array with cores of optical fibers of the second two-dimensional array.

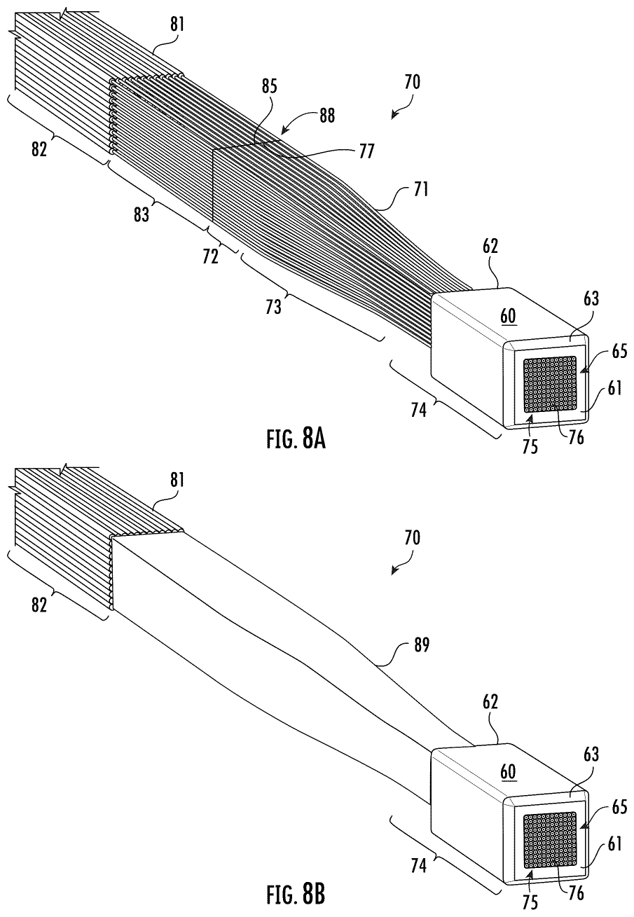

FIG. 8A is a perspective view of an optical fiber cable assembly 70 according to one embodiment having fusion spliced optical fibers of two different types. The optical fiber cable assembly 70 includes first optical fibers 71 (i.e., a quantity of 144 first optical fibers 71) each having a core, cladding, and hard coating layer arranged in a first array 75 (e.g., a 12×12 array) terminated by a ferrule 60. The first optical fibers 71 are joined at a fusion splice region 88 to stripped portions 83 of second optical fibers 81 (i.e., a quantity of 144 second optical fibers 81) each being devoid of a hard coating layer, with the stripped portions 83 of the second optical fibers 81 having a core and cladding (but devoid of a hard coating layer), and with unstripped portions 82 of the second optical fibers 81 further including outer polymeric coating layers over the cladding (and also devoid of a hard coating layer). Prior to fusion bonding, portions (e.g., up to about 4 mm in length) of the first optical fibers 71 proximate to the rear ends 77 may be stripped of the hard coating layer by a cleaning arc of a fusion splicer. The second optical fibers 81 are arranged in a second array 85 (e.g., a 12×12 array). Optionally, the unstripped portions 82 of the second optical fibers 81 may comprise multiple ribbons (e.g., 12 ribbons each containing 12 second optical fibers 81). In certain embodiments, the fusion splice region 88 may be formed by mass fusion splicing of groups of optical fibers 71 of the first array 75 and groups of optical fibers 81 of the second array 85 (e.g., by simultaneously forming twelve fusion splices in a one-dimensional array, and repeating the process eleven more times). Each group of fusion spliced optical fibers may be coated with thermoplastic material after fusion splicing is completed (e.g., with thermoplastic hotmelt material to any desired overall thickness, such as 0.1 mm to 0.35 mm), and the aggregated groups of thermoplastic coated optical fibers may be reflowed (e.g., in the cavity of a mold to provide controllable dimensions) and then cooled to form a compact protected fusion splice region 99. The first array 75 includes a (smaller) first fiber pitch region 74 that extends through aperture 65 of the ferrule 60, a (larger) second fiber pitch region 72 adjacent to the fusion splice region 88, and a pitch transition region 73 intermediately arranged between the first and second fiber pitch regions 74, 72. The aperture 65 of the ferrule 60 extends between a front end face 61 and a rear end face 62 thereof, wherein front ends 76 of the first optical fibers 71 are terminated substantially flush with the front end face 61 (having associated beveled portion 63) of the ferrule 60, and rear ends 77 of the first optical fibers are positioned at the fusion splice region 88.

FIG. 8B shows the optical fiber cable assembly of FIG. 8A, following addition of a protective coating 89 over the fusion splice region as exposed portions of the array 85 of second optical fibers 81 and portions of the array 75 of first optical fibers 71. In certain embodiments, the protective coating 89 may be formed by placing a portion of the cable assembly 70 (including the fusion splice region 88 and exposed portions of the first and second optical fibers 71, 81) of FIG. 8A into a mold cavity (not shown), flowing molten thermoplastic material into the mold cavity, and allowing the molten thermoplastic to cool and solidify around the previously exposed portions of the first optical fibers 71 and the second optical fibers 81. As shown, the protective coating 89 may comprise a maximum lateral dimension that comparable to (e.g., no greater than, or no more than 5% greater than, or no more than 10% greater than) a maximum aggregate lateral dimension of the coated portions 82 of the second optical fibers 81.

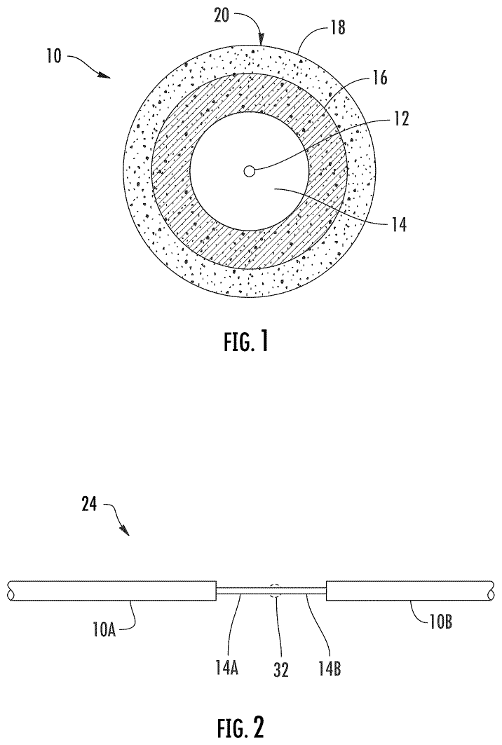

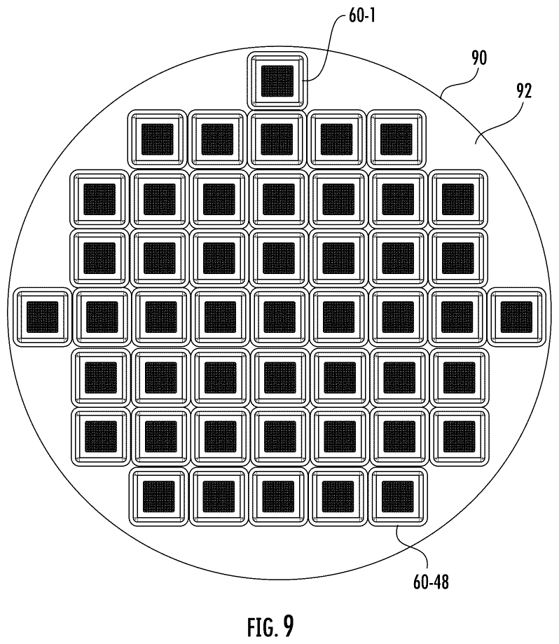

By terminating a high density array of reduced diameter optical fibers having a hard coating layer within a ferrule having a lateral dimension comparable to the aggregate maximum lateral dimension of a corresponding an unstripped array of optical fibers, staggered lengths of cable portions necessary for coupling ultra-high density optical fiber cables can be reduced in number or eliminated altogether. For example, FIG. 9 is front elevational view of an optical fiber cable assembly including forty-eight ferrules 60-1 to 60-48 (e.g., each terminating 144 hard coated optical fibers, for a total of 6,912 terminated fibers) in the interior 92 of a pulling grip 90. The interior 92 of the pulling grip 90 may have an inner diameter of 26 mm. The pulling grip 90 may have a maximum lateral dimension (e.g., outer diameter) that is comparable to (e.g., no more than five percent greater than) that of an ultra-high density fiber optical cable from which fibers terminated by the ferrules 60-1 to 60-48 emanate. In the illustrated embodiment, a need for staggered lengths of cable portions is eliminated entirely, since the pulling grip 90 may be easily pulled through a conduit or other structure housing a cable of corresponding dimensions. In certain embodiments, each ferrule 60-1 to 60-48 includes a two-dimensional array of 72 to 432 optical fibers, or 72 to 288 optical fibers, or 72 to 144 optical fibers. In certain embodiments, each ferrule 60-1 to 60-48 may comprises a ferrule 60 as illustrated and described herein in connection with FIGS. 1-6 with any suitable number of optical fibers terminated therein.

In one embodiment, an optical fiber assembly comprises an optical fiber cable including a plurality of optical fibers in a numerical range of from 1,728 to 13,824 optical fibers, and having a cable outer diameter, wherein the optical fiber assembly further comprises a pulling grip having an outer diameter no more than 5 percent greater than the cable outer diameter, and a plurality of ferrules each terminating a different subgroup of the plurality of optical fibers to form a plurality of terminated subgroups. Each terminated subgroup of the plurality of terminated subgroups comprises 72 to 432 optical fibers. Additionally, each terminated subgroup of the plurality of terminated subgroups has substantially the same length, or the plurality of terminated subgroups consists of terminated subgroups having no more than three different staggered lengths (e.g., one, two, or three, but not four or more). The pulling grip 90 of FIG. 9 may be used in one example as a component of such an optical fiber assembly.

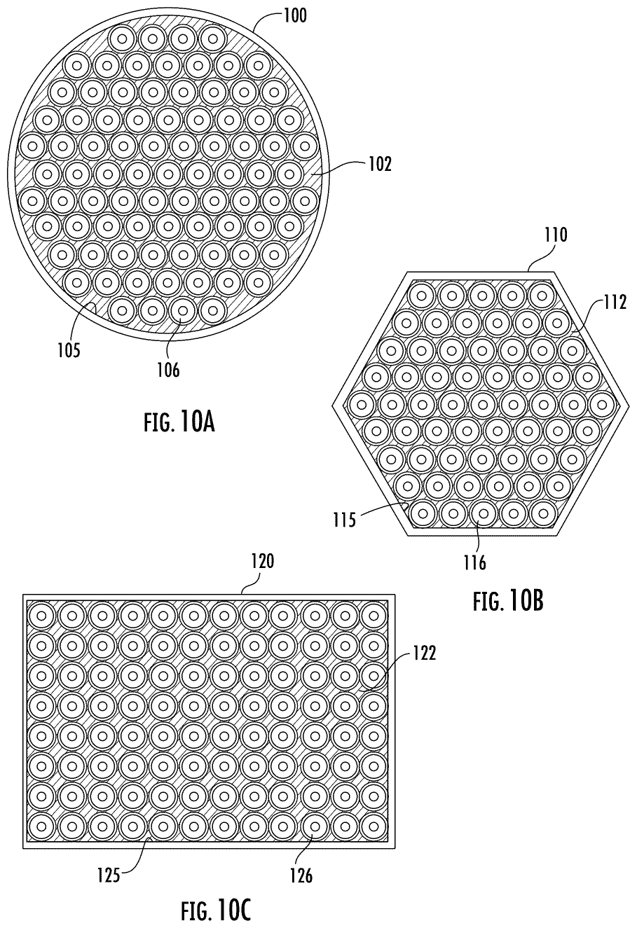

Although various ferrules illustrated in the accompanying drawings have been illustrated as having substantially square cross-sectional shapes, as noted previously herein, a ferrule useable with embodiments herein may comprise any desired cross-sectional shape (e.g., including, but not limited to, square, rectangular, round, hexagonal, and regular or irregular polygon shapes) with. For example, FIG. 10A is a front elevational view of at least a portion of an optical fiber cable assembly including a ferrule 100 with a round cross-sectional shape having a two-dimensional array of optical fibers 106 each having a hard coating layer and a constant fiber pitch arranged within a ferrule aperture 105, wherein adhesive and/or encapsulant material 102 may be arranged in interstitial spaces between the optical fibers 106 and an inner surface of the ferrule 100 defining the ferrule aperture 105. FIG. 10B is a front elevational view of at least a portion of an optical fiber cable assembly including a ferrule 110 with a hexagonal cross-sectional shape having a two-dimensional array of optical fibers 116 each having a hard coating layer and having a constant fiber pitch arranged within a ferrule aperture 115, wherein adhesive and/or encapsulant material 112 may be arranged in interstitial spaces between the optical fibers 116 and an inner surface of the ferrule 110 defining the ferrule aperture 115. FIG. 10C is a front elevational view of at least a portion of an optical fiber cable assembly including a ferrule 120 with a rectangular cross-sectional shape having a two-dimensional array of optical fibers 126 each having a hard coating layer and having a constant fiber pitch arranged within a ferrule aperture 125, wherein adhesive and/or encapsulant material 122 may be arranged in interstitial spaces between the optical fibers 126 and an inner surface of the ferrule 120 defining the ferrule aperture 125. In any of the preceding embodiments, the optical fibers 106, 116, 126 may emanate from a high density optical fiber cable including polymeric material coated optical fibers (with groups thereof optionally arranged in ribbons, such as conventional one-dimensional or rollable ribbons).

One important applications of ultra-high density cable assemblies disclosed herein is for pre-terminated high fiber count outside plant cables. Low fiber count or lower density connectors require large number of stagger lengths as described previously. To classify the fiber density of the termination ferrules, Table 1 (below) compares the cross section area of three ferrule types assuming the use of optical fibers with a 200 μm diameter coating assuming such optical fibers are stacked in a square or rectangular array.

TABLE 1

| | 24 fiber | 144 fiber | 144 fiber UHD |
|---|---|---|---|
| | MPO | matched pair | (ferrule 60 of |
| | connector | connector | FIGS. 1-6 herein) |
| Fiber cross | 0.96 | 5.76 | 5.76 |
| section (mm²) | | | |
| Ferrule cross | 21 mm² | 50.2 mm² | 6.25 mm² |
| section (mm²) | (3 mm × 7 mm) | (ϕ8 mm) | (2.5 mm × 2.5 mm) |
| Fiber/ferrule | 4.6% | 11.5% | 92.2% |
| area ratio | | | |

Referring to Table 1, existing commercially available ferrules (e.g., MPO-type) have a low fiber/ferrule area ratio of around 5%. Matched pair high fiber count connectors (which already suffer from the drawback of not being randomly matable with other connectors) enable the fiber/ferrule area ratio to be increased to about 11.5%, assuming the use of an 8 mm ferrule diameter. It is unlikely that the fiber/ferrule area ratio of matched pair high fiber count connectors can be increased beyond about 20% due to the structural limitation of the ferrule. However, ultra-high density ferrules as disclosed herein (including but not limited to the ferrule 60 illustrated and described in connection with FIGS. 1-6) provides a fiber-ferrule area ratio of 92.2%, which represents a dramatic improvement over existing ferrule technologies.

In cable assemblies according to various embodiments of the present disclosure, fiber/ferrule area ratio values may range from 50% to 150%, or from 75% to 125%, or from 90% to 115%.

Those skilled in the art will appreciate that various modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents. The claims as set forth below are incorporated into and constitute part of this detailed description.

It will also be apparent to those skilled in the art that unless otherwise expressly stated, it is in no way intended that any method in this disclosure be construed as requiring that its steps be performed in a specific order. Accordingly, where a method claim below does not actually recite an order to be followed by its steps or it is not otherwise specifically stated in the claims or descriptions that the steps are to be limited to a specific order, it is no way intended that any particular order be inferred.

What is claimed is:

1. A high fiber count, ferrule-terminated optical fiber cable assembly, comprising:
a ferrule body having a front end face, a rear end face, and an aperture extending between the front end face and the rear end face;
a first two-dimensional array of optical fibers having a substantially constant first fiber pitch extending through the aperture of the ferrule body and terminated at the front end face, each optical fiber of the first two-dimensional array comprising a core, a cladding layer, and a hard coating layer having a Young's modulus greater than 100 MPa, wherein each optical fiber of the first two-dimensional array has an outer diameter in a range of 100 microns to 150 microns;
wherein, within the aperture of the ferrule body, each optical fiber in the first two-dimensional array is arranged within two microns of each adjacent optical fiber in the first two-dimensional array.

2. The optical fiber cable assembly of claim 1, wherein at least some optical fibers in the first two-dimensional array are arranged in contact with one or more adjacent optical fibers of the first two-dimensional array within the aperture of the ferrule body.

3. The optical fiber cable assembly of claim 1, wherein:
each optical fiber of the first two-dimensional array comprises a stripped region and an unstripped region, wherein in the unstripped region each optical fiber comprises the core, the cladding layer, the hard coating layer, and at least one outer polymeric coating disposed around the hard coating layer, and wherein in the stripped region each optical fiber is devoid of an outer polymeric coating disposed around the hard coating layer, the stripped region including an end stripped region and a medial stripped region;
the end stripped region of each optical fiber of the first two-dimensional array extends within the aperture of the ferrule body;
the first two-dimensional array comprises a second fiber pitch corresponding to the unstripped region of each optical fiber of the first two-dimensional array, the second fiber pitch being greater than the first fiber pitch; and
for each optical fiber of the first two-dimensional array, a pitch transition area including the medial stripped region is arranged between the unstripped region and the end stripped region.

4. The optical fiber cable assembly of claim 1, further comprising:
a second two-dimensional array of optical fibers, each optical fiber of the second two-dimensional array comprising a stripped region and an unstripped region, wherein in the stripped region each optical fiber comprises a core and a cladding layer, and in the unstripped region each optical fiber comprises the core, the cladding layer, and at least one outer polymeric coating layer disposed around the cladding layer; and
a fusion splice region between the first two-dimensional array of optical fibers and the stripped region of the second two-dimensional array of optical fibers, wherein each optical fiber of the first two-dimensional array of optical fibers is fusion spliced to a corresponding fiber of the second two-dimensional array of optical fibers;
wherein the first two-dimensional array of optical fibers has a fiber pitch that transitions from a larger fiber pitch proximate to the fusion splice region to a smaller fiber pitch proximate to the ferrule.

5. The optical fiber cable assembly of claim 4, further comprising a thermoplastic material encapsulating the fusion splice region.

6. The optical fiber cable assembly of claim 1, wherein the ferrule body comprises an outer shape selected from square, rectangular, round, and hexagonal.

7. The optical fiber cable assembly of claim 1, further comprising adhesive material arranged in interstitial spaces between optical fibers of the first two-dimensional array within the aperture of the ferrule body.

8. The optical fiber cable assembly of claim 1, wherein the hard coating layer has a thickness in a range of from 1 μm to 15 μm.

9. The optical fiber cable assembly of claim 1, wherein the ferrule body has a length in a range of from 3 mm to 15 mm.

10. The optical fiber cable assembly of claim 1, wherein the first two-dimensional array comprises at least 72 optical fibers.

11. A high fiber count, ferrule-terminated optical fiber cable assembly, comprising:
a ferrule body having a front end face, a rear end face, and an aperture extending between the front end face and the rear end face; and
a plurality of optical fibers each having a stripped region and an unstripped region, wherein in the stripped region each optical fiber comprises a core, a cladding layer, and a hard coating layer having a Young's modulus greater than 100 MPa, and in the unstripped region each optical fiber comprises the core, the cladding layer, the hard coating layer, and at least one outer polymeric coating layer disposed around the hard coating layer, the stripped region including an end stripped region and a medial stripped region;
the plurality of optical fibers in the end stripped region forms a first two-dimensional array having a first fiber pitch extending through the aperture and being terminated at the front end face, and the plurality of optical fibers in the unstripped region forms a second two-dimensional array having a second fiber pitch that is larger than the first fiber pitch.

12. The optical fiber cable assembly of claim 11, wherein:
the ferrule body has a first maximum lateral dimension taken parallel to the front end face;
the second two-dimensional array has a second maximum lateral dimension; and
the second maximum lateral dimension is no more than two times greater than the first maximum lateral dimension.

13. The optical fiber cable assembly of claim 12, wherein the second maximum lateral dimension is no greater than the first maximum lateral dimension.

14. The optical fiber cable assembly of claim 11, wherein at least some optical fibers in the first two-dimensional array are arranged in contact with adjacent optical fibers of the first two-dimensional array within the aperture of the ferrule body.

15. The optical fiber cable assembly of claim 11, wherein, for each optical fiber of the plurality of optical fibers, a pitch transition area including the medial stripped region is arranged between the unstripped region and the end stripped region.

16. The optical fiber cable assembly of claim 11, wherein the ferrule body comprises an outer shape selected from square, rectangular, round, and hexagonal.

17. The optical fiber cable assembly of claim 11, further comprising adhesive material arranged in interstitial spaces between optical fibers of the first two-dimensional array within the aperture of the ferrule body.

18. The optical fiber cable assembly of claim 11, wherein the hard coating layer has a thickness in a range of from 1 μm to 15 μm.

19. The optical fiber cable assembly of claim 11, wherein the ferrule body has a length in a range of from 3 mm to 15 mm.

20. The optical fiber cable assembly of claim 11, wherein the first two-dimensional array comprises at least 72 optical fibers.

21. A high fiber count, ferrule-terminated optical fiber cable assembly, comprising:
an optical fiber cable comprising a plurality of optical fibers in a numerical range of from 1,728 to 13,824 optical fibers, and having a cable outer diameter;
a pulling grip having an outer diameter within 5 percent of the cable outer diameter;
a plurality of ferrules each terminating a different subgroup of the plurality of optical fibers to form a plurality of terminated subgroups, wherein each terminated subgroup of the plurality of terminated subgroups comprises 72 to 432 optical fibers;
wherein each terminated subgroup of the plurality of terminated subgroups has substantially the same length, or the plurality of terminated subgroups consists of terminated subgroups having no more than three different staggered lengths.

22. The optical fiber cable assembly of claim 21, wherein:
each ferrule of the plurality of ferrules comprises a ferrule body having a front end face, a rear end face and an aperture extending between the front end face and the rear end face; and
each terminated subgroup of the plurality of terminated subgroups comprises a two-dimensional array of optical fibers extending through an aperture of a corresponding ferrule of the plurality of ferrules and terminated at the front end face of the corresponding ferrule.

23. The optical fiber cable assembly of claim 21, wherein, within each two-dimensional array of optical fibers, each optical fiber comprises a core, a cladding layer, and a hard coating layer having a Young's modulus greater than 100 MPa, and each optical fiber has an outer diameter in a range of 100 microns to 150 microns.

24. The optical fiber cable assembly of claim 23, wherein, within each ferrule of the plurality of ferrules, each optical fiber in the two-dimensional array of optical fibers is arranged within two microns of each adjacent optical fiber of the two-dimensional array of optical fibers.

25. The optical fiber cable assembly of claim 23, wherein, within each ferrule of the plurality of ferrules, at least some optical fibers in the two-dimensional array of optical fibers is arranged in contact with one or more adjacent optical fibers of the two-dimensional array of optical fibers.
